(19) United States
(12) Patent Application Publication
(10) Pub. No.: US 2015/0363846 A1
(43) Pub. Date: Dec. 17, 2015

(54) Systems and Methods for the Multi-Dimensional Organization of Items

(71) Applicant: Cyrus Farudi, Boulder, CO (US)

(72) Inventor: Cyrus Farudi, Boulder, CO (US)

(21) Appl. No.: 14/740,153

(22) Filed: Jun. 15, 2015

Related U.S. Application Data
(60) Provisional application No. 62/012,845, filed on Jun. 16, 2014.

(51) Int. Cl. G06Q 30/06; G06Q 10/08; G06F 17/30

(52) U.S. Cl. CPC G06Q 30/0601; G06F 17/30592; G06Q 10/087

(57) ABSTRACT

The present disclosure provides a computer-implemented method for organizing items, such as merchant products and/or services, comprising storing identifying information of a plurality of items in an electronic storage unit, and generating a toroidal relationship among said identifying information. Next, the identifying information can be organized per the toroidal relationship. The organized identifying information can then be made accessible to a user.

### CROSS-REFERENCE

This application claims priority to U.S. Provisional Patent Application No. 62/012,845, filed Jun. 16, 2014, which is entirely incorporated herein by reference.

### BACKGROUND

Online shopping or e-shopping is a form of electronic commerce which allows consumers to directly buy goods or services from a merchant over the Internet using a web browser. An online shop may evoke the physical analogy of buying products or services at a bricks-and-mortar merchant. With the growth of online shopping comes a wealth of new market footprint coverage opportunities for merchants that can appropriately cater to various market demands and service requirements.

Shoppers may be attracted to online shopping not only because of high levels of convenience, but also because of broader selections, competitive pricing, and greater access to information. Business organizations may seek to offer online shopping not only because it is of much lower cost compared to bricks and mortar stores, but also because it offers access to a worldwide market, increases customer value, and builds sustainable capabilities.

Merchants can present their products and/or services to shoppers using user interfaces, which can enable shoppers to view and select products or services. Such user interfaces enable shoppers to browse products and select a subset of products for purchase.

As part of the online shopping process, the presentation of merchandise may play a role in improving the profitability of merchants and providing a tailored shopping experience for the shopper. Some merchants may adopt a space planning approach that may be based on local shopper insight and buying behavior using historical sales and performance data.

### SUMMARY

As online shopping becomes more prevalent, shoppers are increasingly turning to online shopping as a replacement for bricks-and-mortar shopping. This advantageously enables shoppers to search for products and services without having to travel to a merchant that may be inaccessible.

Despite the growth of online shopping, recognized herein are various issues with present online shopping approaches. For instance, the presentation of products and services to shoppers in a meaningful manner is problematic. In some cases, such presentation does not approach the physical presentation of products, as may be experienced by shoppers who visit a merchant's physical store. In some instances, products are presented online in a disjointed manner—for example, similar products (e.g., televisions) are presented alongside one another, which may make it difficult for user (or shopper) to view other products.

The present disclosure provides methods and systems for presenting information to a user in a meaningful manner. In the context of shopping, such methods and systems can be used to present merchant products and/or services to a shopper in a manner that enables the shopper to readily and seamlessly browse products and/or services across various product and/or service categories. Products and/or services of a merchant can be presented across multiple categories in a multidimensional manner, and within each category the user can browse products in a manner that may better approximate the physical (in store) shopping experience.

An aspect of the present disclosure provides a computer-implemented method for organizing items, comprising storing identifying information of a plurality of items in an electronic storage unit, and using a computer processor, generating a toroidal relationship among the identifying information. Next, in the electronic storage unit, the identifying information is organized per the generated toroidal relationship. The identifying information can then be made accessible to a user.

In an embodiment, the items are products and/or services of a merchant. In another embodiment, the method further comprises grouping the identifying information into at least a first category and a second category, wherein the first category relates to a first subset of products and/or services among the plurality of products and/or services, and the second category relates to a second subset of products and/or services among the plurality of products and/or services. In another embodiment, the method further comprises generating (i) a first toroidal relationship among identifying information for the first subset in the first category, and (ii) a second toroidal relationship among identifying information for the second subset in the second category. In another embodiment, the method further comprises organizing (i) identifying information for the first subset per the first toroidal relationship, and (ii) identifying information for the second subset per the second toroidal relationship. In another embodiment, the method further comprises preparing at least one of the first and second subsets for display on the electronic display of the user. In another embodiment, the identifying information is product identifying that is selected from the group consisting of product brand, product type, product genre and product description.

In another embodiment, the method further comprises preparing the identifying information for display on an electronic display of a user. The electronic display can be part of an electronic device of the user. The electronic device can be a mobile electronic device. In another embodiment, the method further comprises identifying directional relationships among the identifying information; based on identified directional relationships, linking individual identifying information to at least a subset of the identifying information; and storing linked identifying information in the electronic storage unit.

In another aspect, a computer readable medium comprises machine executable code that, upon execution by one or more computer processors, implements any of the methods above or elsewhere herein.

In another aspect, a computer system comprises one or more computer processors and memory coupled thereto. The memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a method for organizing identifying information and making the organized identifying information accessible to a user;

FIG. 2 schematically illustrates a torus that organizes identifying information in a toroidal fashion;

FIG. 3 schematically illustrates an example data space that includes multiple nodes of identifying information;

FIG. 4 schematically illustrates a computer system that is programmed or otherwise configured to implements methods and systems of the present disclosure;

FIG. 5 schematically illustrates a data space in which nodes of identifying information of products of a merchant are presented in a hexagonal arrangement; and

FIG. 6 shows an example method of presenting products of a merchant to a user.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “user,” as used herein, generally refers to an individual or entity that employs the use of systems and methods of the present disclosure, such as, for example, to browse products, services or products and services of a merchant. A user can be a shopper. A user can be a shopper that browses products and/or services of a merchant and selects one or at least a subset of products or services of the merchant for further review and, in some cases, purchase.

The term “item,” as used herein, generally refers to any electronic or physical object. Items can be tangible objects or electronic objects that may correspond to tangible objects. Items can include content, such as textual content, graphical content, audio content, video content, or a combination thereof. Content can be art content, science or engineering content, or content directed to learning. Examples of items include art, books, journals, magazines, electronics, images, audio, music and video. An item can be a data set, such as, for example, a data set of text, images, audio and/or video.

### Methods for Organizing Identifying Information

In an aspect, the present disclosure provides methods for organizing and browsing items, such as merchant products and/or services, art, data with images, or other data. Such items can be electronic items that relate to physical items. In some examples, an item can correspond to a physical product or service of the merchant. This can enable a user to browse items in a manner similar to browsing items in the physical world, such as, for example, products of a merchant in a department store, music in a music store, video in a video store, or books in a library.

Methods of the present disclosure can be implemented using a computer system that is programmed or otherwise configured to organize identifying information of items, such as products and/or services of a merchant. The identifying information can be organized and stored in a manner that enables a user to readily browse the identifying information and select a subset for further review, such as for purchase.

Methods and systems of the present disclosure can be used to organize products and/or services of a merchant. In some embodiments, a method for organizing merchant products and/or services comprises storing identifying information of a plurality of products and/or services of a merchant in an electronic storage unit, such as, for example, memory. The identifying information can be collected and aggregated by accessing a data storage repository of the merchant, such as a database of the merchant.

In some cases, identifying information can be grouped into at least 1, 2, 3, 4, 5, 6, 7, 8, 9, 10, 20, 30, 40, 50, 60, 70, 80, 90, or 100 categories (e.g., Women, Men and Kids), and in some cases additional sub-categories, sub-categories of sub-categories, and so on, such as at least 1, 2, 3, 4, 5, 6, 7, 8, 9, 10, 20, 30, 40, 50, 60, 70, 80, 90, or 100 sub-categories (e.g., Women's shoes, Women's clothes and Women's jewelry). In an example, the identifying information is grouped into at least a first category and a second category. The first category can relate to a first subset of products and/or services among the plurality of products and/or services, and the second category can relate to a second subset of products and/or services among the plurality of products and/or services.

Next, using a computer processor, a toroidal relationship can be generated among the identifying information. The toroidal relationship can include pointers among the identifying information such that the identifying information is presented in data space in a manner that resembles a torus. This can permit the identifying information to be multi-directionally traversed with no boundaries. In some situations, this enables the identifying information to be traversed in data space without any boundaries along at least one dimension, thus giving the impression of a torus. The toroidal relationship can be generated using a multi-dimensional linked list, for example. As an alternative, the computer processor can generate other relationships among the identifying information. Such relationships can have other geometric shapes, such as spherical or box-like (e.g., box or rectangular cross-section).

In some cases, multiple toroidal relationships may be generated for identifying information in each of a plurality of categories and sub-categories. In an example, a first toroidal relationship is generated among identifying information in a first category and a second toroidal relationship is generated among identifying information in a second category.

In some cases, multiple toroidal relationships are generated and stored for future access by a user. As an alternative, a single toroidal relationship is generated at a given point in time, and additional toroidal relationships can be dynamically generated upon request by a user, such as upon the application of a data filter. For example, a first toroidal relationship can be generated for a given product category (e.g., Kids). When the user wishes to drill down (e.g., vertically) from the product category (e.g., drill down to Kids shoes), a new toroidal relationship can be generated for the new drilled-down product category (e.g., Kids shoes). The new toroidal relationship can be generated dynamically upon request by a user to drill down, or can be generated in advance and stored in memory for use at a future point in time.

The multiple toroidal relationships can be non-concentric rings that are stacked vertically, which can enable a user to drill up or down to various levels, such as product categories, sub-categories, etc. The size of a toroidal relationship at a given level can be different. In some examples, the size can scale with the number of items presented at a given level. For example, a first level having 100 items can be larger in size than a second level having 20 items. As an alternative, the multiple toroidal relationships can be concentric rings, and a user can drill up or down with respect to a common center of the concentric rings.

A toroidal relationship can be generated by identifying directional relationships among the identifying information, as described elsewhere herein. A directional relationship can point a first identifying information to a second identifying information. Next, based on identified directional relationships, individual identifying information can be linked to at least a subset of a remainder of identifying information. The linked identifying information can then be stored in the electronic storage unit.

In the electronic storage unit, the identifying information can be organized per the toroidal relationship that has been generated. In some examples, the identifying information can be organized such that, in data space, the identifying information can be traversed across a surface of a torus. If multiple toroidal relationships have been generated, then identifying information can be organized per each toroidal relationship that has been generated.

In an example, identifying information of products and/or services of a merchant comprises a first subset and a second subset of products and/or services. Identifying information for the first subset can be organized per a first toroidal relationship and identifying information for the second subset can be organized per a second toroidal relationship.

The organized identifying information can be made accessible to a user. In some cases, the organized identifying information is prepared for display on an electronic display of a user. The user can be a shopper that may wish to select at least one product and/or service of the merchant. In some situations, upon the selection of a product and/or service by the user, the merchant can deliver or otherwise make the product and/or service available to the user. If multiple subsets of identifying information have been organized, then at least one of the multiple can be prepared for display on the electronic display of the user.

An electronic display can be part of an electronic device of the user, such as, for example, a mobile (or portable) electronic device. The electronic display can be a passive display or an active display, such as a touchscreen. The electronic display can be a two-dimensional or three-dimensional display. The electronic display can enable user navigation using gestures, for example.

In some cases, the organized identifying information is presented to the user in a user interface (UI) on the electronic display of the user. The UI can be a graphical user interface (GUI) or a web-based UI. The UI can be two-dimensional or three-dimensional. In some cases, the UI is two-dimensional and presented to the user on a two-dimensional display. As an alternative, the UI is three-dimensional and presented to the user on pseudo-three dimensional medium, which can be accessible, for example, using a virtual reality display (e.g., a virtual reality head-mounted display).

The identifying information can be an attribute of a product or service of the merchant. In some cases, the identifying information is selected from the group consisting of brand, type, genre and description. In an example, the identifying information is product brand (e.g., Boss® and Armani®). In another example, the identifying information is product type (e.g., clothes, shoes and jewelry). The identifying information can be presented by way of data or metadata.

Once identifying information has been presented to the user, the user may elect to view additional detail(s) of a product or service associated with the identifying information. The additional detail(s) can include additional attributes of the product or service. The system can then present the additional attributes to the user. In some cases, the system can enable the user to conduct a transaction with respect to the product and/or service of the merchant, such as purchase the product and/or service of the merchant.

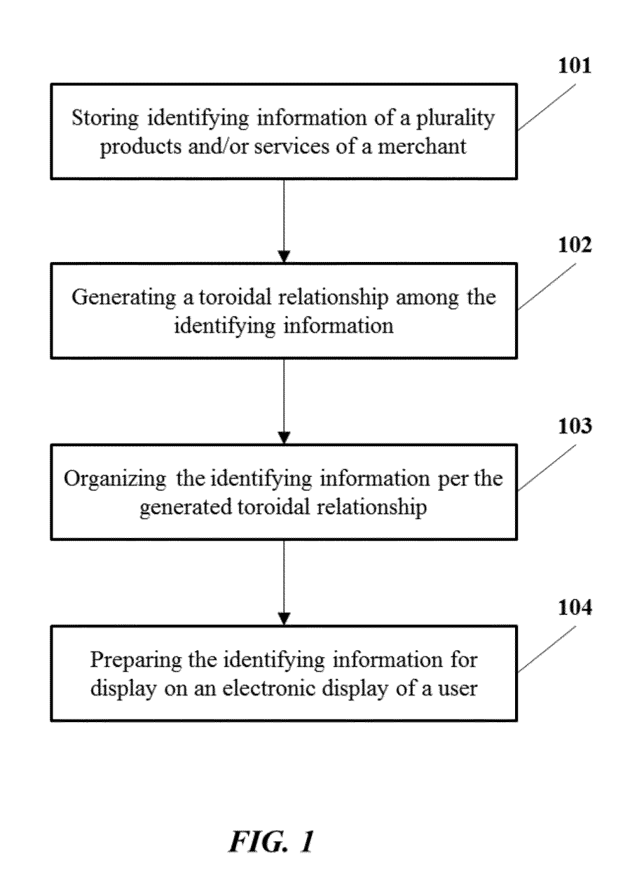

FIG. 1 schematically illustrates a method for organizing identifying information and making the organized identifying information accessible to a user. The method can be implemented using a computer system that is programmed or otherwise configured to organize identifying information of products and/or services of a merchant.

In a first operation 101, identifying information of a plurality products and/or services of a merchant is stored in an electronic storage unit, such as memory. In some cases, this can include accessing a computer system of the merchant to identify and aggregate the identifying information.

Next, in a second operation 102, at least one toroidal relationship among the identifying information is generated. In some cases, multiple toroidal relationships among the identifying information can be generated, such as at least 2, 3, 4, 5, 6, 7, 8, 9, 10, 20, 30, 40, 50, 60, 70, 80, 90, 100, 200, 300, 400, 500, or 1000 toroidal relationships. Each relationship can include, for example, linkers (or pointers) among individual identifying information and at least a subset of a remainder of the identifying information.

Next, in a third operation 103, the identifying information can be organized per the generated toroidal relationship. In some cases, the identifying information can be organized per a plurality of generated toroidal relationships. The organized identifying information can then be stored in an electronic storage unit, such as memory.

Next, in a fourth operation 104, the organized identifying information can be made accessible to a user. This can include preparing the organized identifying information for display on an electronic display of a user.

The organized identifying information can be made accessible to the user upon a search performed by the user. The search can be directed at the products and/or services of the merchant, or other items. The search can include one or more keywords directed to a product and/or service of the merchant (e.g., “women's jeans”).

The user can be presented with a reference point, which can include a location at which the user started browsing items, such as, for example, the landing point of a collection of merchant products and/or services. The reference point can enable the user to determine whether the user has reviewed certain items. In an example, the beginning of a collection of products of a merchant is indicated by a graphical element (e.g., different color box). The graphical element can inform the user of the beginning and end of the collection of products. As the user traverses a toroidal collection, the reference point can help the user assess where the user is with respect to a beginning, middle, or end of the collection.

Although certain relationships herein have been described as toroidal or resembling a torus, other relationships and shapes are possible. For example, items can be grouped according to a geometric shape that is spherical or box-like (e.g., box or rectangular cross-section). Other geometric shapes or combinations of different shapes may be possible, such as a combination of toroidal and box-like shapes or spherical and box-like shapes.

Levels (e.g., categories and sub-categories) can be traversed in various ways, such as vertically or horizontally. In some cases, upon drilling up or down among levels, the scale of a previous level or subsequent level may change with respect to another level. For example, in drilling to a lower level, the scale of the previous, higher level may decrease and the scale of the lower level may increase.

### Multi-Dimensional Linked Lists

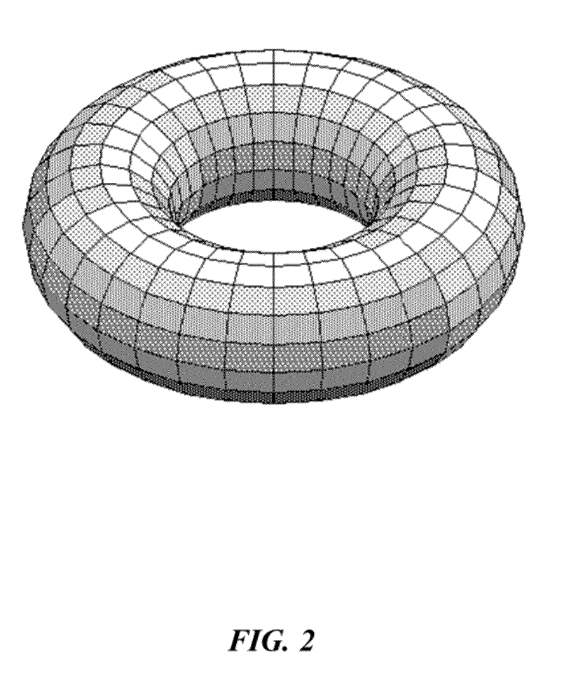

In another aspect, the present disclosure provides methods for linking identifying information of products and/or services of a merchant. Such methods can be used to organize identifying information in a toroidal fashion, i.e., along a surface of a torus, as shown in FIG. 2. The surface of the torus can be traversed in data space with no apparent boundary along a given dimension.

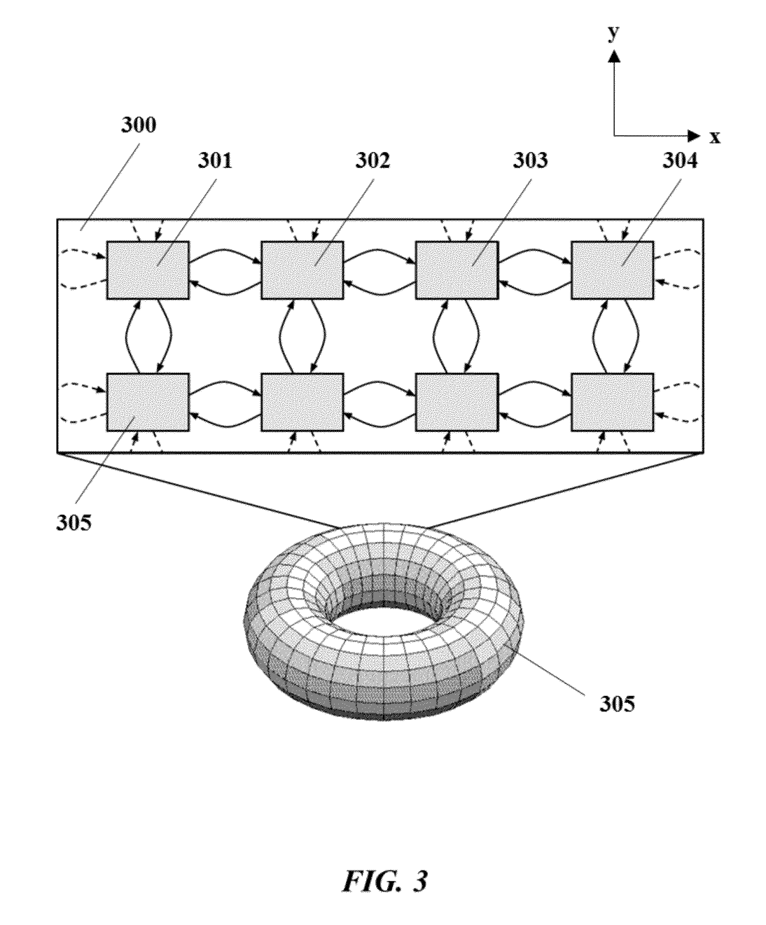

In some embodiments, a multi-dimensional linked list can be used to generate toroidal relationships among identifying information. Identifying information can be represented as a record or node in data space (see, e.g., FIG. 3). Each record or node can be multi-directionally (e.g., bi-directionally) linked to another record or note, such as, for example, its neighbor, through some common relationship of information, such as metadata. This can provide a linked list that can be traversed in multiple (e.g., two) directions, such as along x and y-dimensions in a Cartesian data space.

FIG. 3 shows an example data space 300 that includes multiple nodes of identifying information, including a first node 301, second node 302, third node 303, fourth node 304 and fifth node 305. The first node 301 is linked to a second node 302, the second node 302 is linked to a third node 303, and the third node 303 is linked to a fourth node 304. The fourth node 304 is linked to the first node 301. The first node 301 is linked to a fifth node 305. When the nodes 301-304 are traversed (e.g., upon a user browsing the nodes), traversal beyond the fourth node 304 can lead to the first node 301, giving the impression that there is no boundary in the data space. This can give the user the impression that the data space can be traversed in a given dimension substantially indefinitely.

The data space 300 of FIG. 3 (top image) can be traversed from node to node along the x and y axes. Because each node is linked to at least one other node, the data space of FIG. 3 has no apparent boundary, in a manner similar to a torus 305.

In some cases, the multi-dimensional linked list is mapped to a torus and stored in an electronic storage unit with such mapping. In some cases, the list can be circularly linked in the x and y spaces such that there is no terminator node, which can allow for the apparent indefinite traversal of the list. In some examples, the last node in the list can point to the first node in the list, and vice versa. In some instances, because the list can be multi-directionally linked, each record may not need to keep track of its neighbor, and any node can be used to traverse the list in any direction.

Filters can be applied to the identifying information, which can permit a user to view one or more select subsets of identifying information. When a filter is applied, the system can form a new multi-dimensional linked list, reducing the size of the list and allowing for more targeted traversal of desired relationships. This can permit toroidal relationships to be generated dynamically. As an alternative, various linked lists are formed and stored in memory, and when a filter is applied, a given linked list is accessed from memory and used to arrange identifying information for review by a user.

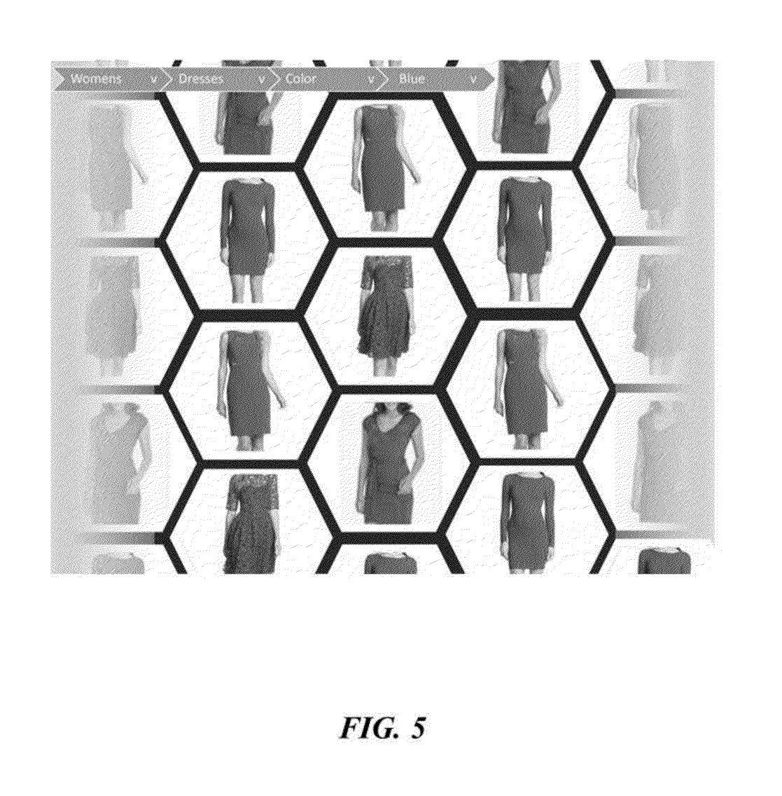

In a data space, nodes of identifying information can be linked to one or more other nodes. A node can be linked to at least 1, 2, 3, 4, 5, 6, 7, 8, 9, 10, 20, 30, 40, 50, 60, 70, 80, 90, or 100 other nodes. In an example, a node is linked to 2, 3, 4, 5, or 6 other nodes. This can provide a data space in which nodes are disposed in a square, rectangular, pentagonal or hexagonal fashion (see, e.g., FIG. 5, which shows nodes in a hexagonal arrangement).

A data space can include a marker that makes reference to a reference point. The reference point can include the location at which the user started browsing items, such as, for example, the landing point of a collection of merchant products. The reference point can enable the user to determine that the user has reviewed certain items. In an example, the beginning of a collection of products of a merchant is indicated by a graphical element (e.g., different color box), which informs the user of the beginning and end of the collection of products. As the user traverses a toroidal collection, the reference point can help the user assess where the user is with respect to a beginning, middle, or end of the collection.

### Computer Systems

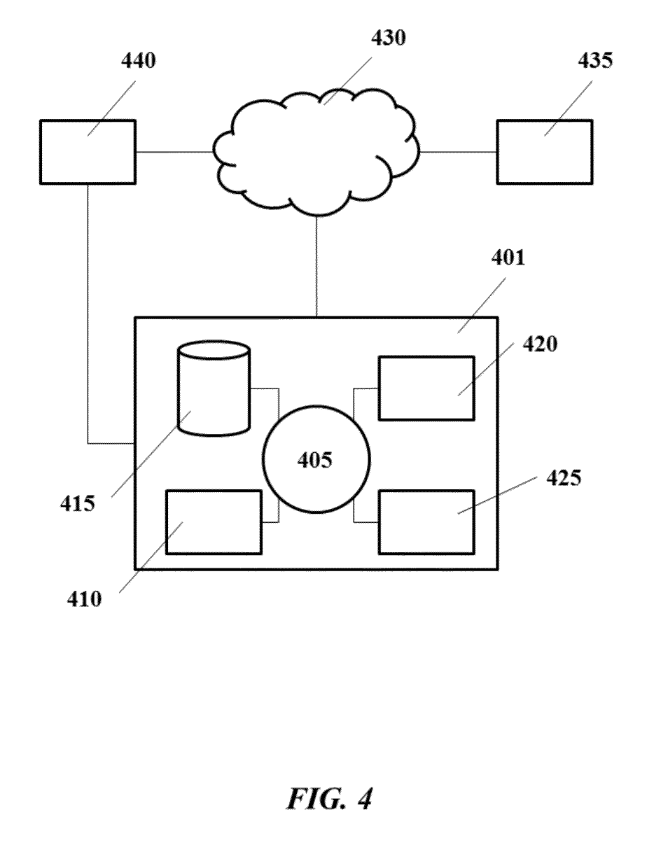

The present disclosure provides computer systems that are programmed or otherwise configured to implement methods of the disclosure. FIG. 4 shows a computer system 401 that is programmed or otherwise configured to organize identifying information of products and/or services of a merchant.

The computer system 401 includes a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are external to the computer system 401, such as located on a remote server that is in communication with the computer system 401 through an intranet or the Internet.

The computer system 401 can communicate with one or more other computer systems either directly or through the network 430. For instance, the computer system 401 can communicate with a remote computer system of a user 435 (e.g., shopper) and a computer system of a merchant 440. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 401 via the network 430. The computer system of the merchant 440 can include one or more storage units, which can store product and/or service identifying information.

Methods as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display that comprises a user interface (UI) for providing, for example, identifying information of products and/or services of a merchant for view by a user. Examples of UI's include, without limitation, a graphical user interface (GUI) and web-based user interface.

Methods and systems of the present disclosure can be implemented by way of one or more algorithms. An algorithm can be implemented by way of software upon execution by one or more computer processors. In some examples, an algorithm is for generating toroidal relationships among identifying information for products and/or services of a merchant.

Systems of the present disclosure can be provided as data warehouses that can be programmed or otherwise configured to store and organize merchant information. Such data warehouses can include extract, transform and load (ETL) algorithms that can access databases of merchant and (i) extract identifying information of products and/or services of the merchant, (ii) transform the information, such as to generate toroidal relationships among the information, and (iii) load the information into the data warehouse for future access by users.

Systems and methods of the present disclosure can be used to access and collect content (e.g., images, audio, and/or video) from a data source (e.g., the Internet), and index and store the content in an electronic data storage repository. Such items can then be organized according to methods provided herein and made accessible to a user.

### EXAMPLE 1

FIG. 5 shows a data space in which nodes of identifying information of products of a merchant (e.g., Nordstrom®) are presented in a hexagonal arrangement. The data space can be implemented by a computer system that is programmed or otherwise configured to generate data space, such as the computer system 401 of FIG. 4. The data space can be part of a toroidal relationship of data in a given product sub-category (Women's→Dresses→Color→Blue), which can be a sub-category of several higher level sub-categories and categories.

The data can be stored in an electronic data storage unit with such hexagonal arrangement preserved, and presented to a user in a user interface (UI) on a two-dimensional or three-dimensional display. In an example, the arrangement of nodes of FIG. 5 is presented to a user in a hexagonal arrangement on an electronic display of the user, similar to what is what is shown in FIG. 5. The UI can include a menu bar that shows categories and sub-categories (or levels) of products and/or services. The menu bar can be located at various locations of the UI, such as at the top or bottom of the UI. The menu bar can static or dynamically updated based on the categories and sub-categories viewed by the user.

The user can scroll left, right, up, down, and in various angular (e.g., diagonal) directions to browse products. The user can select a given product to view additional information about the product. In an example, selecting a given product generates a new user interface element over the hexagonal arrangement of FIG. 5. The new user interface can include additional information about the product.

The user can drill up to higher sub-categories or drill down to narrower sub-categories. For example, the user can elect to view a higher level category (Women's→Dresses). The system in such a case can generate a new toroidal relationship of products in the higher level category, either dynamically or statically (e.g., the relationship has been previously generated and stored in memory), and presented products to the user based on the new toroidal relationship.

### EXAMPLE 2

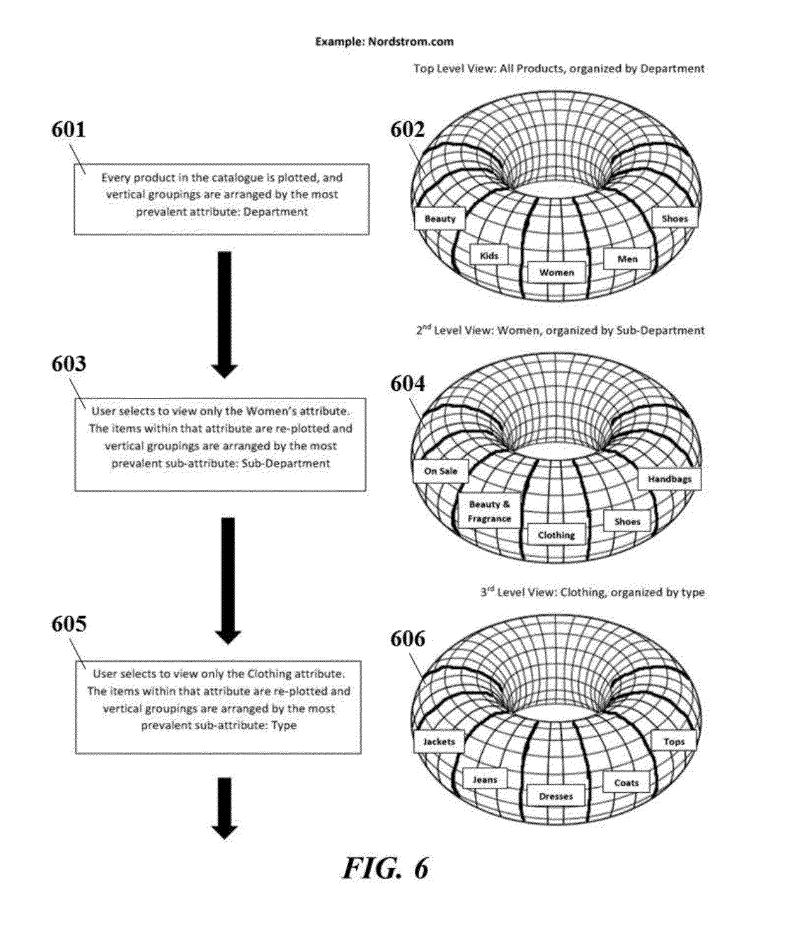

FIG. 6 shows an example method of presenting products of a merchant (e.g., Nordstrom®) to a user. The method can be implemented by a computer system that is programmed or otherwise configured to organize identifying information of products of a merchant, such as the computer system 401 of FIG. 4.

In a first operation 601, in a top-level view, products are organized by the following departments: “Beauty,” “Kids,” “Women,” “Men” and “Shoes.” Products may be organized and stored in a toroidal data space 602 in memory, which has multiple subsets of categories, such as “Beauty,” “Kids,” “Women,” “Men” and “Shoes.” Every product in a catalogue of the merchant can be plotted on a user interface (UI) of an electronic display of an electronic device of the user, and vertical groupings can be arranged by the most prevalent attribute (e.g., Department).

In a second operation 603, the user can drill down (or navigate down) to a lower level and select to view the Women's sub-category having only Women's attributes, for example. Items (e.g., products) in the Women's sub-category may be organized and stored in a toroidal data space 604 in memory, which has multiple subsets products in sub-categories, such as “On Sale,” “Beauty & Fragrance,” “Clothing,” “Shoes” and “Handbags.” The items within the Women's sub-category can be rendered and re-plotted on the UI of the electronic display of the user, and vertical groupings can be arranged by the most prevalent sub-attribute (e.g., Sub-department). The user can select any product to view identifying information for the product. Alternatively, the user can select any sub-category to drill down further to view other sub-categories.

In a third operation 605, the user can drill down to a lower level to view products having the “Clothing” attribute. Products in the Clothing sub-category may be organized and stored in a toroidal data space 606 in memory, which has multiple subsets of products in sub-categories, such as “Jackets,” “Jeans,” “Dresses,” “Coats” and “Tops.” The items within the Clothing sub-category can be rendered and re-plotted on the UI of the user, and vertical groupings can be arranged by the most prevalent sub-attribute (e.g., Type). The user can select any product to view identifying information for the product. Alternatively, the user can select any sub-category to drill down further to view other sub-categories.

Because products and subsets of products are organized in a toroidal fashion, the user can freely navigate along a data space within a given category or sub-category and not face any apparent boundary or endpoint during navigation. This can enable the user to freely view products of the merchant within a given level and to drill up or down (vertically) to other levels to view other products, in a manner that may be similar to traveling along a surface of a torus along a given direction. Because data is organized per a toroidal relationship, navigation at a given level can seem boundless.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for organizing items, comprising:
(a) storing identifying information of a plurality of items in an electronic storage unit;
(b) using a computer processor, generating a toroidal relationship among said identifying information;
(c) in said electronic storage unit, organizing said identifying information per said toroidal relationship generated in (b); and
(d) making said identifying information accessible to a user.

2. The method of claim 1, wherein said items are products and/or services of a merchant.

3. The method of claim 2, further comprising, prior to (b), grouping said identifying information into at least a first category and a second category, wherein said first category relates to a first subset of products and/or services among said plurality of products and/or services, and said second category relates to a second subset of products and/or services among said plurality of products and/or services.

4. The method of claim 3, wherein (b) further comprises generating (i) a first toroidal relationship among identifying information for said first subset in said first category, and (ii) a second toroidal relationship among identifying information for said second subset in said second category.

5. The method of claim 4, wherein (c) further comprises organizing (i) identifying information for said first subset per said first toroidal relationship, and (ii) identifying information for said second subset per said second toroidal relationship.

6. The method of claim 5, wherein (d) further comprises preparing at least one of said first and second subsets for display on said electronic display of said user.

7. The method of claim 2, wherein said identifying information is product identifying that is selected from the group consisting of product brand, product type, product genre and product description.

8. The method of claim 1, wherein (d) comprises preparing said identifying information for display on an electronic display of a user

9. The method of claim 8, wherein said electronic display is part of an electronic device of said user.

10. The method of claim 9, wherein said electronic device is a mobile electronic device.

11. The method of claim 1, wherein (c) comprises:
identifying directional relationships among said identifying information;
based on identified directional relationships, linking individual identifying information to at least a subset of the identifying information; and
storing linked identifying information in said electronic storage unit.

12. A computer system for organizing items, comprising:
a communications interface that is in communication with an electronic device of a user over a network;
an electronic storage unit that stores identifying information of a plurality of items; and
a computer processor in communication with said communications interface and said electronic storage unit and programmed to (i) generate a toroidal relationship among said identifying information in said electronic storage unit, (ii) organize said identifying information per said toroidal relationship generated in (i) in said electronic storage unit; and (iii) make said identifying information accessible to said user through said communications interface.

13. The computer system of claim 12, wherein said items are products and/or services of a merchant.

14. The computer system of claim 12, wherein said computer processor is programmed to group said identifying information into at least a first category and a second category, wherein said first category relates to a first subset of products and/or services among said plurality of products and/or services, and said second category relates to a second subset of products and/or services among said plurality of products and/or services.

15. The computer system of claim 14, wherein said computer processor is programmed to generate (1) a first toroidal relationship among identifying information for said first subset in said first category, and (2) a second toroidal relationship among identifying information for said second subset in said second category.

16. The computer system of claim 15, wherein said computer processor is programmed to organize (1) identifying information for said first subset per said first toroidal relationship, and (2) identifying information for said second subset per said second toroidal relationship.

17. The computer system of claim 16, wherein said computer processor is programmed to prepare at least one of said first and second subsets for display on said electronic display of said user.

18. The computer system of claim 12, wherein said computer processor is programmed to prepare said identifying information for display on an electronic display of a user

19. The computer system of claim 18, wherein said electronic display is part of an electronic device of said user.

20. The computer system of claim 12, wherein said computer processor is programmed to:
identify directional relationships among said identifying information;
based on identified directional relationships, link individual identifying information to at least a subset of the identifying information; and
store linked identifying information in said electronic storage unit.
